(19) United States
(12) Patent Application Publication
(10) Pub. No.: US 2026/0100908 A1
(43) Pub. Date: Apr. 9, 2026

(54) Effective LAG Load Distribution via L2 Source Forwarding/Routing

(71) Applicant: Ciena Corporation, Hanover, MD (US)

(72) Inventors: Marc Holness, Nepean (CA); Bashar Abdullah, Kanata (CA); David Gilson, Honolulu, HI (US)

(73) Assignee: Ciena Corporation, Hanover, MD (US)

(21) Appl. No.: 18/908,032

(22) Filed: Oct. 7, 2024

(51) Int. Cl. H04L 47/122; H04L 45/24; H04L 47/20

(52) U.S. Cl. CPC H04L 47/122; H04L 45/245; H04L 47/20

(57) ABSTRACT

Systems and methods provide Link Aggregation Group (LAG) load distribution via Layer 2 (L2) source forwarding/routing in a network. An apparatus includes circuitry configured to monitor a status of the network, and, responsive to new traffic from an access node, determine a path in one or more LAGs in the network, each LAG of the one or more LAGs includes multiple links aggregated together as a single logical link, wherein the path is determined between the access node and other nodes in the network based on the status. The circuitry can be further configured to provide instructions to the access node for forwarding the new traffic on the determined path.

### FIELD OF THE DISCLOSURE

The present disclosure relates generally to networking. More particularly, the present disclosure relates to systems and methods for effective Link Aggregation Group (LAG) load distribution via Layer 2 (L2) source forwarding/routing.

### BACKGROUND OF THE DISCLOSURE

Link Aggregation Group (LAG) in Layer 2 combines multiple physical network links into a single logical link to increase bandwidth and/or provide redundancy. LAG distributes traffic across these links using a hashing algorithm, which assigns packets to specific links based on attributes such as source/destination Media Access Control (MAC) addresses, Internet Protocol (IP) addresses, and port numbers. This ensures that packets within the same flow use the same link, while different flows can be distributed across multiple links. However, the distribution may not always be even, as traffic patterns and flow sizes can cause some links to carry more traffic than others. The effectiveness of the hashing algorithm is highly dependent on incoming traffic patterns. Because hashing distributes traffic based on packet attributes, if traffic flows are diverse, the algorithm can spread the load more effectively across all links. However, if the traffic patterns are skewed, such as when a large proportion of traffic is between a small number of source-destination pairs, the hashing algorithm may assign most of the traffic to a few links, leading to uneven load distribution. This can result in some links being overutilized while others remain underutilized, reducing the overall bandwidth efficiency of the LAG.

### BRIEF SUMMARY OF THE DISCLOSURE

The present disclosure relates to systems and methods for effective Link Aggregation Group (LAG) load distribution via Layer 2 (L2) source forwarding/routing. Recognizing the hashing-based approach for load distribution may not result in even distribution, the present disclosure does not rely on the hashing-based approach but rather employs a L2 source forwarding/routing solution to improve traffic load distribution in a network. An example of L2 source forwarding/routing includes Virtual Local Area Networks (VLAN) path segments created by VLAN cross connects at intermediate nodes. Other approaches for L2 source forwarding/routing are contemplated, such as static (i.e., managed) forwarding table entries which can be used to create the VLAN path segments (i.e., L2 tunnels). Specifically, L2 source forwarding/routing means the load distribution is handled by a Path Computation Element (PCE) which determines how traffic is distributed using VLANs, instead of using hashing to select the path in the LAG. The PCE indicates which Traffic Engineered (TE) VLAN path is used by an incoming traffic flow. The PCE can be centrally located or distributed across the access nodes. Bandwidth utilization of links in the network is communicated to the PCE which analyzes the bandwidth utilization for assigning new traffic flows. L2 techniques provide deterministic load balancing overcoming limitations of the hash-based approach in LAGs.

In various embodiments, the present disclosure includes a method having steps, an apparatus such as circuitry or a network element configured to implement the steps, and a non-transitory computer-readable medium storing instructions that, when executed, cause circuitry to implement the steps. The steps are for Link Aggregation Group (LAG) load distribution via Layer 2 (L2) source forwarding/routing in a network, and the steps include monitoring a status of the network; and, responsive to new traffic from an access node, determining a path in one or more LAGs in the network, each LAG of the one or more LAGs includes multiple links aggregated together as a single logical link, wherein the path is determined between the access node and other nodes in the network based on the status. The steps can further include providing instructions to the access node for forwarding the new traffic on the determined path. The steps can further include configuring the access node and the other nodes for the forwarding. The instructions can include Virtual Local Area Network (VLAN) Identifiers (VID) for tagging packets of the newly arriving traffic. The path can be determined between the access node and other nodes in the network based on the status in lieu of using a hashing algorithm in the one or more LAGs to select one of the links associated therewith. The path can be determined between the access node and other nodes in the network based on the status to perform load distribution in the network. The status can include information about network topology, link states, bandwidth availability, and traffic congestion in the network, such that the determination of the path is based thereon.

### BRIEF DESCRIPTION OF THE DRAWINGS

The present disclosure is detailed through various drawings, where like components or steps are indicated by identical reference numbers for clarity and consistency.

FIG. 1 illustrates an example network including access nodes A1, A2, . . . , Ak that connect to aggregation nodes B, C in a LAG which also connect to a node D via another LAG.

FIG. 2 illustrates the network of FIG. 1 with a PCE and with managed/static forwarding entries for directing traffic flows from the access nodes A1, A2, . . . , Ak.

FIG. 3 illustrates the network of FIGS. 1 and 2 with a centralized approach for the PCE.

FIG. 4 illustrates the network of FIGS. 1 to 3 with a distributed approach for the PCE.

FIG. 5 illustrates the network of FIGS. 1 to 4 with a link between the aggregation node B and the core node D down due to a fault.

FIG. 6 illustrates the network of FIGS. 1 to 5 with example link utilization values listed for illustration purposes.

FIG. 7 illustrates the network of FIGS. 1 to 6 with different example link utilization values from FIG. 6 listed for illustration purposes.

FIG. 8 illustrates a block diagram of a network element, depicted in a simplified functional format.

FIG. 9 illustrates a block diagram of an example processing device.

FIG. 10 illustrates a process for effective Link Aggregation Group (LAG) load distribution via Layer 2 (L2) source forwarding/routing.

### DETAILED DESCRIPTION OF THE DISCLOSURE

Again, the present disclosure relates to systems and methods for effective Link Aggregation Group (LAG) load distribution via Layer 2 (L2) source forwarding/routing. Again, the present disclosure replaces the hash-based load distribution in LAG with a PCE-based approach where the PCE assigns links, using L2 forwarding approaches, e.g., VLAN identifiers (VLANID).

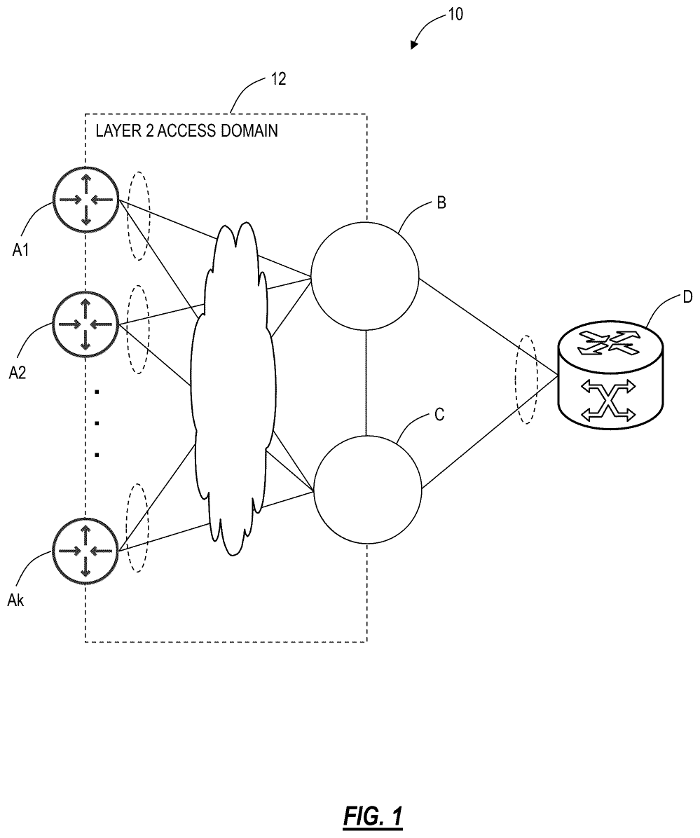

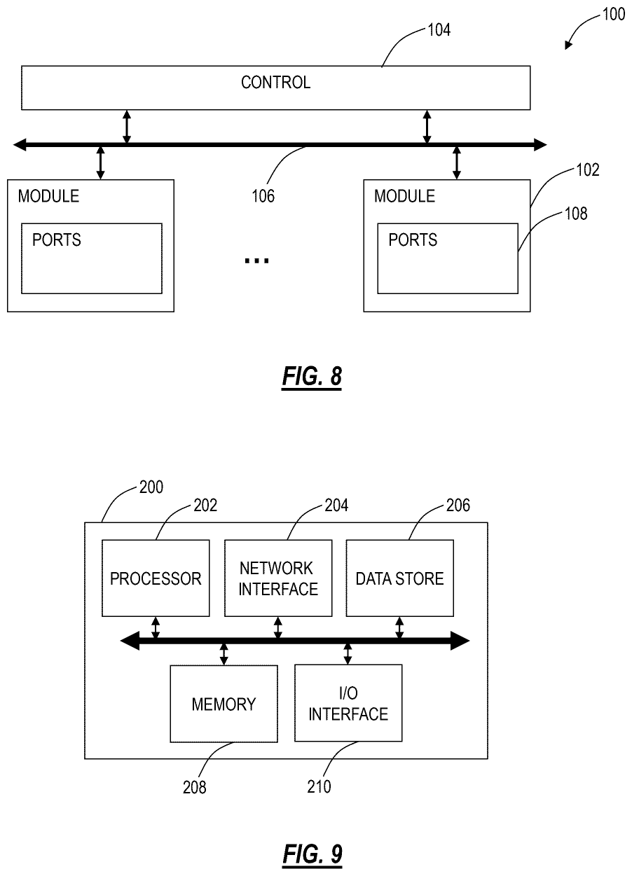

FIG. 1 illustrates an example network 10 including access nodes A1, A2, . . . , Ak that connect to aggregation nodes B, C in a LAG which also connect to a code node D via another LAG. The nodes A1, A2, . . . , Ak, B, C, D can be referred to as network elements, routers, switches, etc. (see FIG. 8 for an example functional architecture of a node), each of which supports L2 connectivity and forwarding. The network 10 is presented for illustration purposes and represents a common network design pattern. However, those skilled in the art will appreciate other configurations are contemplated. Specifically, the techniques for load distribution described herein contemplate any LAG configuration, namely replacing the hashing with PCE-based forwarding. Note, FIG. 1 illustrates two LAGs for illustration, but those skilled in the art will appreciate the L2 load balancing techniques can be used with a single LAG as well.

The access nodes A1, A2, . . . , Ak are in a L2 access domain 12. Upstream traffic (from left to right, i.e., towards the node D) from the access nodes A1, A2, . . . , Ak is dual-homed to the aggregation nodes B, C, which are in turn dual-homed connected to the core node D, i.e., maximum network resilience is the objective. Service Providers that prefer a L2 access technology leverage a load distribution mechanism based upon LAG and Multi-chassis (MC)-LAG (MC-LAG) to support the resiliency. However, another objective in addition to maximum network resilience is maximize overall network utilization by as evenly as possible distributing the load through the L2 access domain 12.

A LAG aggregates multiple physical network links (with common endpoints) into a single logical link to increase bandwidth and improve resiliency. LAG provides load distribution by using hashing algorithms to distribute traffic across the available links, preventing any single link from becoming a bottleneck. If one link fails, the remaining links in the group continue to carry traffic, ensuring network resiliency. MC-LAG extends this concept by allowing links to be aggregated across multiple/disparate network devices (chassis). MC-LAG enhances resiliency further by ensuring that even if one entire device fails, traffic can still flow through the other devices, while also distributing the load across both devices. Both LAG and MC-LAG are crucial for optimizing bandwidth utilization and providing high availability in critical network infrastructures.

The load distribution across the network 10 is provided by LAG distribution algorithms which are used for both LAG and MC-LAG. LAG performs load distribution by spreading network traffic across multiple physical links that are aggregated into a single logical connection. Conventionally, this is done through hashing algorithms that consider various packet attributes, such as source and destination MAC addresses, IP addresses, or Layer 4 port numbers. The algorithm calculates a hash for each packet and maps it to one of the available links within the LAG. This ensures that traffic, from different flows, is distributed across the multiple links, preventing any single link from becoming overloaded. While it distributes traffic effectively across all link members of a LAG, load distribution may not always be perfect, as certain traffic patterns, such as a single large flow, may not fully utilize all links. Nonetheless, LAG provides redundancy, as traffic can still flow even if one link fails.

Because these algorithms are based on the hashing of selective fields found within the incoming packet, load distribution based on these mechanisms may not result in an even distribution of network traffic across all links in a LAG. If many flows share the same hash outcome due to similar attributes, multiple flows may be assigned to the same link, leading to an uneven load across the aggregated links. For example, a single flow can map to exactly one link member in a LAG. So, a large flow of say 110 Gbps would be mapped to a single link member of a 2×100 GE LAG. Even though the LAG is composed of 200 Gbps total bandwidth, a single flow can make use of exactly one link member of the LAG. And if another flow was to arrive and be hashed to that same link member, then one link in the LAG would be overutilized while the other link member would be unused. Similarly, if the hashing algorithm only considers a limited number of attributes, like just the source IP address, and many devices share the same IP range, traffic could become concentrated on a few links, causing imbalance. This uneven distribution reduces the overall efficiency of the LAG's load balancing.

Since the hashing algorithm is not effective, the present disclosure does not rely upon the LAG load distribution mechanism to balance the network traffic across multiple paths. It can be unreliable in evenly distributing traffic load across the network 10. Instead, the present disclosure employs a type of layer 2 source forwarding/routing solution to improve the traffic load distribution across the network 10.

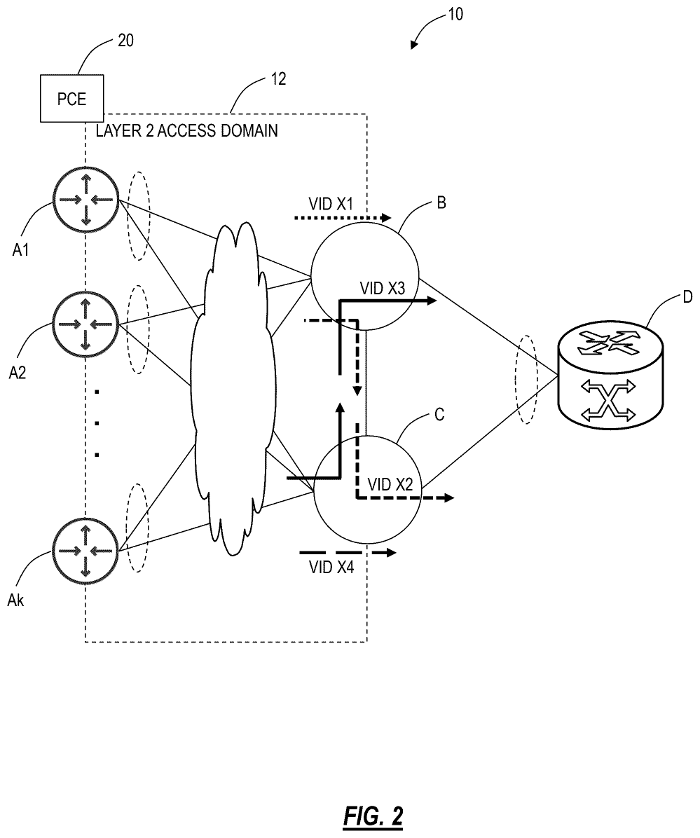

FIG. 2 illustrates the network 10 with a PCE 20 and with managed/static forwarding entries for directing traffic flows from the access nodes A1, A2, . . . , Ak. The PCE 20 is a network component, typically a server or software module, responsible for calculating the most efficient paths for data traffic across the network 10. Once it computes the paths, the PCE communicates the instructions to routers or switches, i.e., the access nodes A1, A2, . . . , Ak, usually through the Path Computation Element Communication Protocol (PCEP). This dynamic path computation allows the network 10 to optimize resource utilization, avoid congestion, and ensure service-level agreements (SLAs) are met, improving overall network performance and resiliency. The present disclosure extends the PCE functionality to replace the hash-based LAG load distribution.

To distribute traffic evenly over multiple links in the network 10 without relying on hashing, the PCE 20 can be used to intelligently select the most optimal links for traffic flows. The PCE 20 dynamically calculates the best available paths based on network conditions, such as link utilization, congestion, and bandwidth requirements. Once the PCE 20 has selected the optimal links, it provides this information to the source access node A1, A2, . . . , Ak. The source access node A1, A2, . . . , Ak then directs traffic flows according to the PCE's instructions, sending data through specific links based on the computed paths. The access node A1, A2, . . . , Ak can force traffic along a selected path using several techniques. VLAN tagging (802.1Q) assigns traffic to specific VLANs that follow predetermined routes, while static MAC address manipulation configures switches to forward traffic over specific ports. Tunneling protocols, such as Multiprotocol Label Switching (MPLS) or Ethernet Virtual Private Network (EVPN), encapsulate traffic with labels that direct it through desired paths. Additionally, manipulating the Spanning Tree Protocol (STP) can adjust the network topology to favor certain paths. These methods enable precise control over traffic flow for traffic engineering purposes, ensuring optimal load distribution, redundancy, and service prioritization. Those skilled in the art will recognize any technique is contemplated for forcing traffic on particular links.

In an example embodiment, in FIG. 2, the aggregation nodes B, C are configured/provisioned with managed/static forwarding entries that will result in the forwarding shown by VLAN Identifiers (VID) {X1, X2, X3, X4}. VIDs are used to segment and direct traffic in the L2 network 10 by tagging Ethernet frames with unique IDs, allowing traffic within the same VLAN to be forwarded only to devices or ports assigned to that VLAN. The PCE 20 can configure and manage VLAN IDs by dynamically assigning them based on utilization to load balance. The PCE 20 ensures that traffic flows over the most efficient paths by selecting VLANs that direct traffic through specific links.

For example, the source access nodes A1, A2, . . . , Ak can dictate which path through the L2 access domain 12, based upon an outer VLAN tag (herein referred to as a multipath VLAN), e.g., {X1, X2, X3, X4}, inserted on the frame being dispatched into the network 10. The PCE 20 can be utilized to determine which multipath L2 path the traffic flow should use to facilitate increased network utilization (i.e., improved network load balancing). To balance the traffic load through the network 10, the PCE 20 will pin the incoming traffic flow to a path through the L2 access domain 12, in such a manner that flows are distributed evenly across the multipath set. This can be used to (significantly) improve the even load distribution (i.e., load balancing) through the L2 access domain 12.

Also, the PCE 20 can take into account bandwidth utilization of network links between the aggregation nodes B, C towards the code node D. The bandwidth utilization of these links as well as the links between the access nodes A1, A2, . . . , Ak and the aggregation nodes B, C is communicated to the PCE 20 (whether within the source nodes or outside of the source nodes). The PCE 20 can direct each flow over a path that would encourage even distribution of network traffic through the network 10.

For example, the PCE 20 can have knowledge of the current bandwidth utilization of all the network links and receive a new traffic flow. The PCE 20 can select a best path based on the current bandwidth utilization and instruct the corresponding access node for the new traffic flow where the corresponding access node can use one of the VIDs {X1, X2, X3, X4} based on the selected links by the PCE 20. Note, having the four VIDs {X1, X2, X3, X4}, the access nodes A1, A2, . . . , Ak can direct the new traffic flow on a desired path to the aggregation nodes B, C towards the code node D. In another example, with just a single LAG, dual-homed to the aggregation nodes B, C, there would just need to be two VIDs.

Again, the example here includes two LAGs, one between the access nodes A1, A2, . . . , Ak and the aggregation nodes B, C and one between the aggregation nodes B, C and the core node D. Here, there are four VIDS {X1, X2, X3, X4} allowing any access node A1, A2, . . . , Ak to send traffic to the core node D via any link, including via a link 22 between the dual homed aggregation nodes B, C. The link 22 is typically referred to as an inter-switch link (ISL) or an inter-chassis link (ICL). The ISL/ICL allows for coordination between the two aggregation nodes B, C., ensuring that traffic is appropriately balanced, and failover mechanisms work properly. In a dual-homing setup, if one of the links between the nodes and the network fails, the ISL/ICL ensures that traffic can still be routed through the remaining active links, providing redundancy and improving network resiliency.

The present disclosure contemplates various PCE algorithms for selecting links for load distribution. In an embodiment, the PCE 20 could select the links with the lowest bandwidth utilization. Other embodiments may also consider characteristics of the new traffic flow, number of hops, etc.

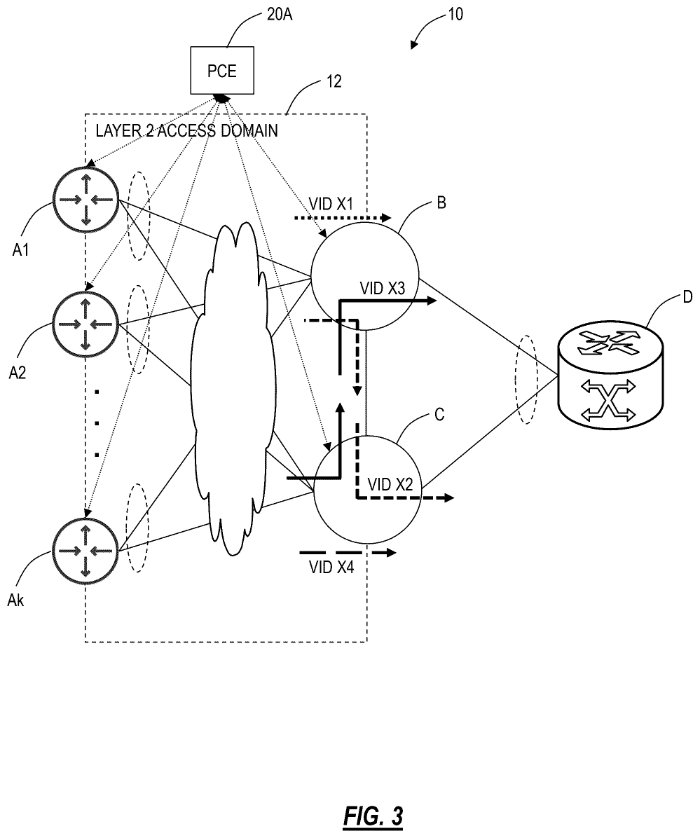

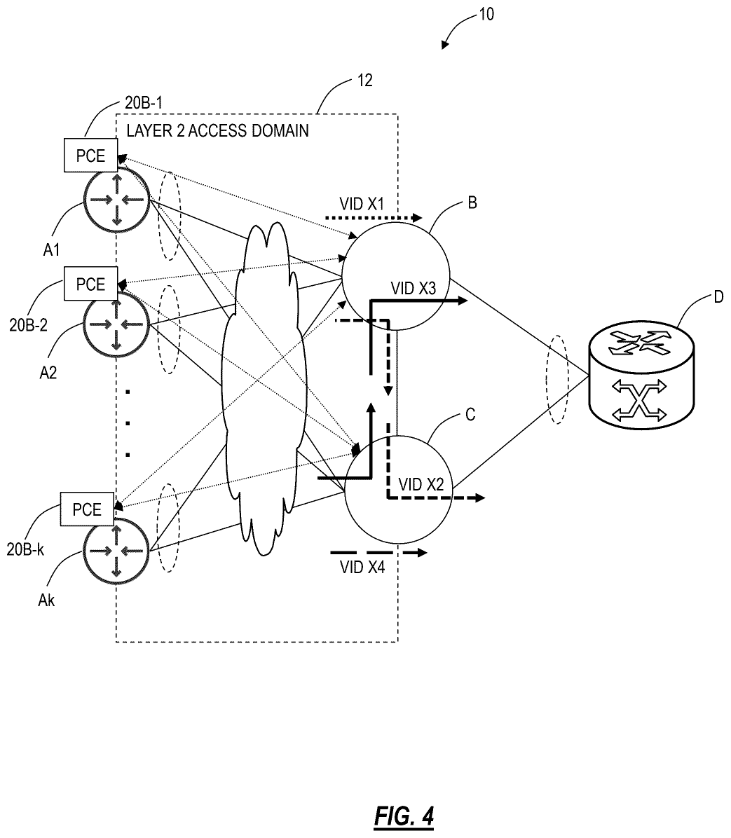

There are two models that can be used by the PCE 20, including a centralized approach illustrated in FIG. 3 with a PCE 20A connected to each of the access nodes A1, A2, . . . , Ak, and a distributed approach illustrated in FIG. 4 with distributed PCEs 20B-1, 20B-2, . . . , 20B-k. A centralized PCE is a single, centralized entity responsible for calculating and managing optimal network paths across the entire network. It gathers information from multiple network devices and computes the best paths, providing a holistic view of the network.

The PCE 20 receives inputs from the network 10, i.e., from any of the nodes A1, A2, . . . , Ak, B, C, D. This can be via protocols like Open Shortest Path First-Traffic Engineering (OSPF-TE) or Border Gateway Protocol-Link State (BGP-LS). These protocols allow the nodes A1, A2, . . . , Ak, B, C, D to regularly update the PCE 20 with information about network topology, link states, bandwidth availability, and traffic congestion. The nodes A1, A2, . . . , Ak, B, C, D share this data through link-state advertisements or similar mechanisms, enabling the PCE to maintain an up-to-date view of the network's status. This real-time information helps the PCE 20 compute optimal paths for traffic based on current network conditions.

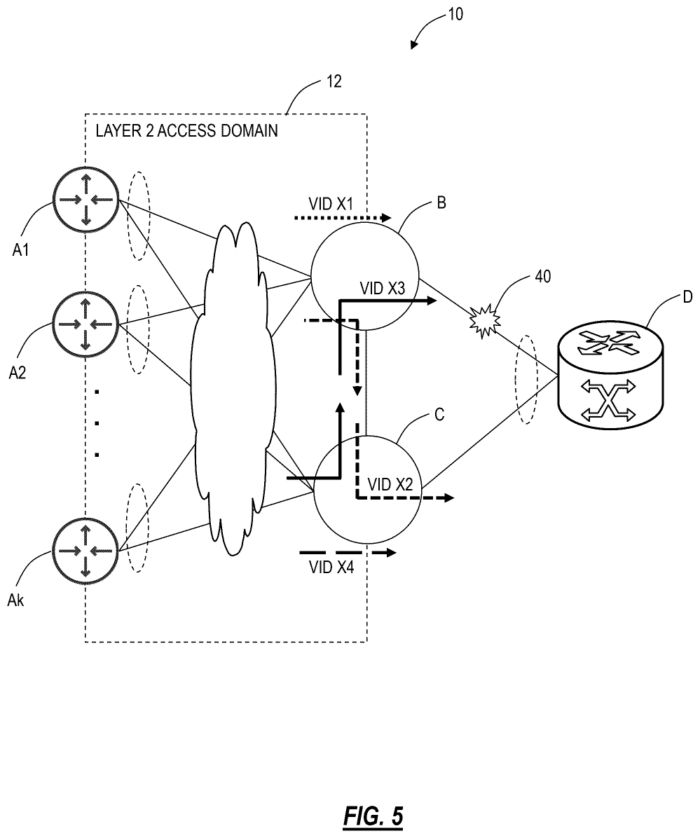

In an example, FIG. 5 illustrates the network 10 with a link between the aggregation node B and the core node D down due to a fault 40. The PCE 20 input from the nodes A1, A2, . . . , Ak, B, C, D can be a simple link status, where if one of the LAG members fails on the LAG towards core device D, then additional flows added to the L2 access domain 12 steer away from that diminished LAG capacity. So, if we assume one (or more) of the LAG members between the nodes B, D fails (where the entire LAG does not fail). If a “new” flow is sourced from access node A1, then the PCE 20 can tell the access node A1 to insert VID X2 or VID X4 on packets for this “new” flow and dispatch from node A1 to node C. This will cause the flow to be forwarded over path {A1→B→C→D} or {A1→C→D}. The PCE(s) 20 thus can increase the even load distribution (i.e., load balancing) throughout the L2 access domain 12.

In an example implementation, the aggregation nodes B, C can have static entries associated with the network path (i.e., VID {X1, X2, X3, X4}) pre-configured. The egress flow-points associated with these network path Forwarding Domains (FDs) are pre-configured using an operation, such as a POP of the outer VLAN tag. At the node A1, the PCE 20 dynamically configures an egress flow-point (towards the node C), associated with the “new”service FD, e.g., an operation to push a VLAN tag (e.g., VID X4).

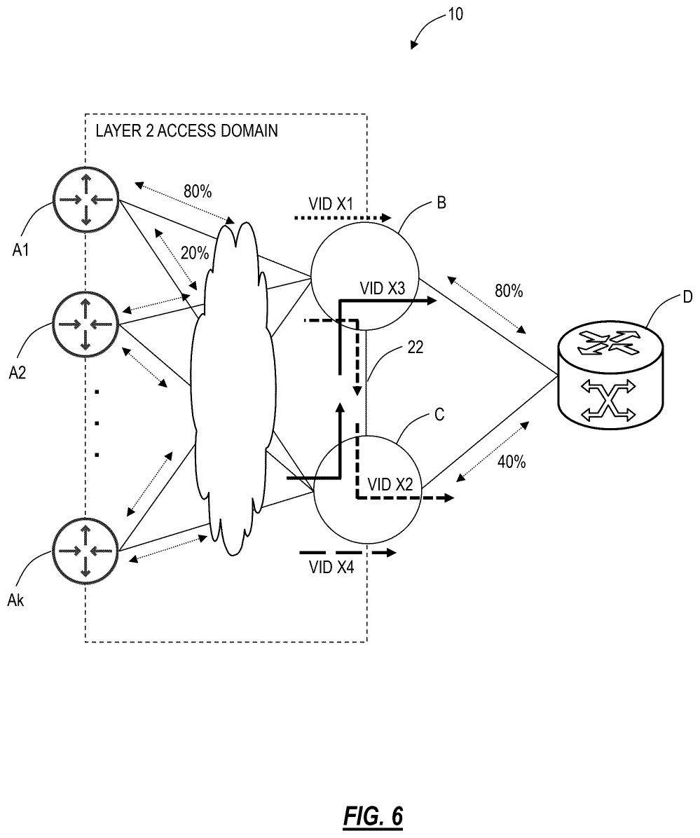

In another example, FIG. 6 illustrates the network 10 with example link utilization values listed for illustration purposes. This is a more sophisticated example from FIG. 5. Assume for bandwidth utilization:

(1) Logical connection between the nodes B, D is 80%

(2) Logical connection between the nodes C, D is 40%

(3) Logical connection between the nodes A1, B is 80%

(4) Logical connection between the nodes A1, C is 20%

If a “new” flow is sourced from the node A1, then the PCE 20 will tell the node A1 to insert VID X4 on packets for this “new” flow to dispatch it from the node A1 to the node C. This will cause the flow to be forwarded over path {A1→C→D}. The PCE(s) 20 thus can increase the even load distribution (i.e., load balancing) throughout the L2 access domain 12.

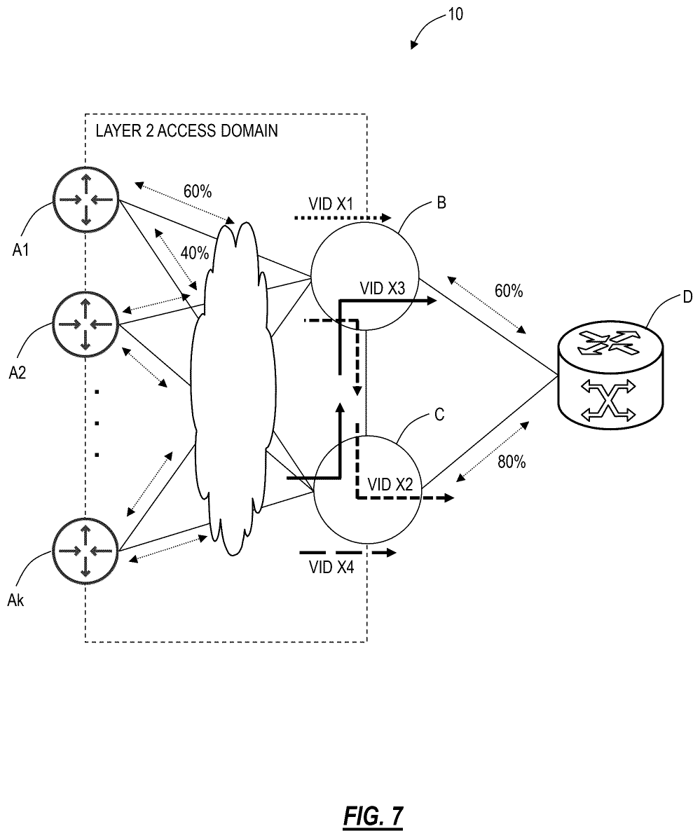

In a further example, FIG. 7 illustrates the network 10 with different example link utilization values from FIG. 6 listed for illustration purposes. Assume for bandwidth utilization:

(1) Logical connection between the nodes B, D is 60%

(2) Logical connection between the nodes C, D C-D is 80%

(3) Logical connection between the nodes A1, B is 60%

(4) Logical connection between the nodes A1, C is 40%

If a “new” flow is sourced from the node A1, then the PCE can tell the node A1 to insert VID X3 on packets for this “new” flow and dispatch from it from the node A1 to the node C. This will cause the flow to be forwarded over path {A1→C→B→D}.

Note, the term logical connection refers to the abstraction of physical links between the described nodes above, i.e., assuming there can be more than one physical link between any two nodes.

Also, those skilled in the art will appreciate the above examples are presented for illustration purposes and are non-limiting, i.e., there can be various different scenarios for using the techniques described herein for load balancing.

FIG. 8 illustrates a block diagram of a network element 100, depicted in a simplified functional format. It is important to note that a more practical design of this network element 100 would likely include additional components and processing logic to accommodate standard operating features, which are not detailed here. The network element 100 may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 100. It may also communicate with external network management systems or databases that handle provisioning and operational data.

Lastly, while FIG. 8 provides a basic view, those skilled in the art will understand that the network element 100 could include additional components or be configured differently, such as in a distributed arrangement or as an integrated, rack-mounted unit (often referred to as a “pizza-box” configuration). This depiction in FIG. 8 is intended to convey functional aspects, with actual hardware implementations varying widely. In various embodiments, the nodes A1, A2, . . . , Ak, B, C, D can utilize the functional structure of the network element 100.

FIG. 9 illustrates a block diagram of an example processing device 200. The processing device 200 may be integrated within the network element 100 or function as a standalone unit connected to the network element 100. It may also be known as an apparatus, a control module, shelf controller, shelf processor, or system controller. The PCE 20 can be implemented via the processing device 200. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, OAM&P data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

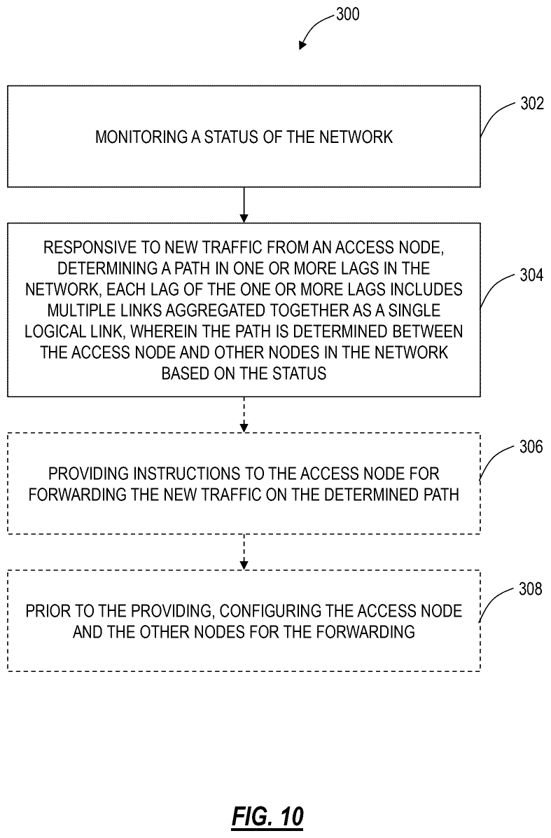

FIG. 10 illustrates a process 300 for effective Link Aggregation Group (LAG) load distribution via Layer 2 (L2) source forwarding/routing. The process 300 contemplates implementation as a method having steps, via an apparatus such as the PCE 20, the processing device 200, or the network element 100 configured to implement the steps, and as a non-transitory computer-readable medium storing instructions that, when executed, cause one or more processors to implement the steps.

The steps include monitoring a status of the network (step 302); and, responsive to new traffic from an access node, determining a path in one or more LAGs in the network, each LAG of the one or more LAGs includes multiple links aggregated together as a single logical link, wherein the path is determined between the access node and other nodes in the network based on the status (step 304). The steps can further include providing instructions to the access node for forwarding the new traffic on the determined path (step 306). The steps can further include, prior to the providing, configuring the access node and the other nodes for the forwarding (step 308). In an embodiment, the instructions include Virtual Local Area Network (VLAN) Identifiers (VID) for tagging packets of the new traffic.

The path is determined between the access node and other nodes in the network based on the status in lieu of using a hashing algorithm in the one or more LAGs to select one of the links associated therewith. The path can be determined between the access node and other nodes in the network based on the status to perform load distribution in the network. The status can include information about network topology, link states, bandwidth availability, and traffic congestion in the network, such that the determining the path is based thereon.

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. An apparatus configured to provide Link Aggregation Group (LAG) load distribution via Layer 2 (L2) source forwarding/routing in a network, the apparatus comprising circuitry configured to:
monitor a status of the network, and
responsive to new traffic from an access node, determine a path in one or more LAGs in the network, each LAG of the one or more LAGs includes multiple links aggregated together as a single logical link, wherein the path is determined between the access node and other nodes in the network based on the status.

2. The apparatus of claim 1, wherein the circuitry is further configured to
provide instructions to the access node for forwarding the new traffic on the determined path.

3. The apparatus of claim 2, wherein the circuitry is further configured to
prior to the instructions being provided to the access node, configure the access node and the other nodes for the forwarding.

4. The apparatus of claim 2, wherein the instructions include Virtual Local Area Network (VLAN) Identifiers (VID) for tagging packets of the new traffic.

5. The apparatus of claim 1, wherein the path is determined between the access node and other nodes in the network based on the status in lieu of using a hashing algorithm in the one or more LAGs to select one of the links associated therewith.

6. The apparatus of claim 1, wherein the path is determined between the access node and other nodes in the network based on the status to perform load distribution in the network.

7. The apparatus of claim 1, wherein the status includes information about network topology, link states, bandwidth availability, and traffic congestion in the network, such that the determining the path is based thereon.

8. The apparatus of claim 1, wherein the apparatus is a Path Computation Element (PCE).

9. A method for Link Aggregation Group (LAG) load distribution via Layer 2 (L2) source forwarding/routing in a network, the method comprising steps of:
monitoring a status of the network; and
responsive to new traffic from an access node, determining a path in one or more LAGs in the network, each LAG of the one or more LAGs includes multiple links aggregated together as a single logical link, wherein the path is determined between the access node and other nodes in the network based on the status.

10. The method of claim 9, wherein the steps further include
providing instructions to the access node for forwarding the new traffic on the determined path.

11. The method of claim 10, wherein the steps further include
prior to the providing, configuring the access node and the other nodes for the forwarding.

12. The method of claim 10, wherein the instructions include Virtual Local Area Network (VLAN) Identifiers (VID) for tagging packets of the new traffic.

13. The method of claim 9, wherein the path is determined between the access node and other nodes in the network based on the status in lieu of using a hashing algorithm in the one or more LAGs to select one of the links associated therewith.

14. The method of claim 9, wherein the path is determined between the access node and other nodes in the network based on the status to perform load distribution in the network.

15. The method of claim 9, wherein the status includes information about network topology, link states, bandwidth availability, and traffic congestion in the network, such that the determining the path is based thereon.

16. A non-transitory computer-readable medium storing instructions for Link Aggregation Group (LAG) load distribution via Layer 2 (L2) source forwarding/routing in a network, the instructions, when executed, cause one or more processors to perform steps of:
monitoring a status of the network; and
responsive to new traffic from an access node, determining a path in one or more LAGs in the network, each LAG of the one or more LAGs includes multiple links aggregated together as a single logical link, wherein the path is determined between the access node and other nodes in the network based on the status.

17. The non-transitory computer-readable medium of claim 16, wherein the steps further include
providing instructions to the access node for forwarding the new traffic on the determined path.

18. The non-transitory computer-readable medium of claim 16, wherein the path is determined between the access node and other nodes in the network based on the status in lieu of using a hashing algorithm in the one or more LAGs to select one of the links associated therewith.

19. The non-transitory computer-readable medium of claim 16, wherein the path is determined between the access node and other nodes in the network based on the status to perform load distribution in the network.

20. The non-transitory computer-readable medium of claim 16, wherein the status includes information about network topology, link states, bandwidth availability, and traffic congestion in the network, such that the determining the path is based thereon.
